(19) United States
(12) Patent Application Publication
(10) Pub. No.: US 2011/0296302 A1
(43) Pub. Date: Dec. 1, 2011

(54) SYSTEM AND METHOD FOR ADVERTISING ON COMPUTING DEVICES

(76) Inventors: Victor Baranov, Toronto (CA); Dmitry Zakharov, Tomsk (RU)

(21) Appl. No.: 13/114,316

(22) Filed: May 24, 2011

Related U.S. Application Data
(60) Provisional application No. 61/396,568, filed on May 27, 2010.

(51) Int. Cl. G06F 3/00

(52) U.S. Cl. 715/700

(57) ABSTRACT

This specification generally relates to systems and methods for advertising on computing devices, wherein an arbitrary application installed on the device can be advertising-enabled with specially designed device side components capable of detecting certain application events, requesting an advertisement, displaying it, and reporting on the user's reaction to the advertisement, assisted by special purpose configuration and advertising servers, such that no specific changes in application are required.

### CROSS-REFERENCE TO RELATED APPLICATION

The present application claims the benefit of U.S. (Provisional) Application No. 61/396,568, filed May 27, 2010, the contents of which are incorporated herein by reference in their entirety.

### FIELD

This specification generally relates to systems and methods for advertising on computing devices. More specifically, the present specification relates to systems and methods for displaying full screen advertisements on computing devices.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

A variety of applications exist for modern computing devices addressing a wide range of problems. The applications are made by companies and independent developers using various tools and techniques. Many of the applications are distributed free of charge or have a very small price tag, which usually does not bring any significant earnings to the developer.

One of the ways to collect or increase revenue for the developers is by advertising. Typically, this involves integrating various sources of advertising content into the applications. Many advertising networks and aggregators exist which provide the developers with a Software Developer Kit (SDK) for integration of the advertisements into the applications. This integration requires modification of source code of the application and, possibly, application logic. For newly developed applications, modification of the source code is not a problem. However, for applications that already exist and for applications that are already installed, it can be problematic to modify the source code.

In light of the foregoing discussion, there is a need for an improved method of advertising on a computing device during an activity of an application, which can overcome one or more drawbacks discussed above.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 shows a block diagram of the hardware of an embodiment of a computing device on which the advertising system may be implemented;

FIG. 2 shows a block diagram of an embodiment of a network system for advertising on computing devices;

FIG. 3 shows a block diagram of an embodiment of an applications activity tracking subsystem of the system of FIG. 1;

FIG. 4 shows a block diagram of an embodiment of an applications activity tracking subsystem of the system;

FIG. 5 shows is a flowchart of an embodiment of a method of detecting an application closing event;

FIG. 6 shows a flowchart of an embodiment of a method of an applications ad subscription retrieval subsystem;

FIG. 7 shows a flowchart of an embodiment of an algorithm of identifying the need for an ad display;

FIG. 8 is a flowchart of an embodiment of an algorithm of an ad display upon application start;

FIG. 9 shows a flowchart of an embodiment of an algorithm of an ad display upon application activation;

FIG. 10 shows a block diagram of an embodiment of an ad display subsystem; and

FIG. 11 shows a flowchart of an embodiment of assembling the system of FIG. 1.

### SUMMARY

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Embodiments of the invention provide systems and methods for advertisement (ad) display in applications installed on mobile or stationary computing devices. The methods and systems do not require any preliminary or subsequent modification of applications and allows ad display in both newly installed and already installed applications. In some embodiments, the methods and systems do not require any modifications to be made to the applications (existing or already installed). The methods and systems provide an easy way for application developers to integrate advertising into their software even if the software is already installed on the computing device(s), and, as such, to take part in advertising revenues.

In some embodiments, the methods are based on tracking of activity of applications running on a computing device. Advertisements are displayed upon detection of certain events. During ad display, user access to the application may be restricted until the user explicitly closes the advertisement or until a certain time elapses. After the ad display, the user may continue to work with the application as normal until another event occurs which initiates another advertisement display.

Typically advertising is displayed only in those applications which are registered on a dedicated server. It is assumed that application developers create an account on the dedicated server and register their applications thereon. The application developers also enter information for transferring payments for ad display. Details of the applications' ad subscription are downloaded from the dedicated server to a computing device through a communication channel. These details may include, for example, application ID, application developer's account ID for ad display registration, as well as parameters of the ad display mechanism.

In some embodiments, a method is provided for displaying a content on at least a portion of a display screen of a computing device, such that the computing device is capable of running an application. The method includes accessing a set of predefined parameters associated with the application and determining the content to be displayed based on the set of predefined parameters. Thereafter, on detection of an event associated with the application, the content is displayed. The method ensures that no modification is required to be made to the applications for displaying the content.

In an embodiment, the content can be an advertising content.

Embodiments of the invention also provide a computing device configured to display a content on at least a portion of a display screen of the computing device. The computing device includes a memory configured to store at least one set of predefined parameters corresponding to at least one application and at least one content. Further, the computing device also includes a tracking module configured to detect an event associated with an application on the computing device. The computing device also includes a processor configured to obtain a set of predefined parameters corresponding to the application, such that the set of predefined parameters enable the processor to identify the content to be displayed out of the at least one content stored in the memory module of the computing device. Thereafter, a display module of the computing device displays the content on the display screen.

Some embodiments of the invention also provide a system for displaying an advertising content on a display screen of a computing device. The system includes a first server including one or more sets of predefined parameters corresponding to one or more applications. The system also includes a second server including one or more advertising contents. The system also includes a computing module that is located on the computing device. The computing module is enabled to at least obtain a set of predefined parameters associated with an application from the first server, obtain an advertising content based on the set of predefined parameters from the second server, detect an event associated with the application, and display the advertising content on the display screen when the event is detected.

In another embodiment, the invention provides a computer program product that includes instruction for enabling the method of displaying the advertising content on the computing device.

Each embodiment disclosed herein may be used or otherwise combined with any of the other embodiments disclosed. Any element of any embodiment may be used in any embodiment.

Any of the above embodiments may be used alone or together with one another in any combination. The advertisement methods and systems encompassed within this specification may also include embodiments that are only partially mentioned or alluded to or are not mentioned or alluded to at all in this brief summary or in the abstract.

The aspects, features, techniques and advantages of the present invention described herein are not all-inclusive, and, in particular, many additional aspects, features, techniques and advantages will be apparent to one of ordinary skill in the art in view of the figures and the following description of the preferred embodiments of the present invention.

The foregoing is the summary and thus contains, by necessity, simplifications, generalizations, and omissions of detail. Those skilled in the art will appreciate that the summary is illustrative only and is not intended to be in any way limiting.

### DETAILED DESCRIPTION

Although various embodiments of the invention may have been motivated by various deficiencies with the prior art, which may be discussed or alluded to in one or more places in the specification, an embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Before describing the present invention in detail, it should be observed that the present invention utilizes a combination of method steps and apparatus components related to a method of advertisement display. Accordingly the apparatus components and the method steps have been represented where appropriate by conventional symbols in the drawings, showing only specific details that are pertinent for an understanding of the present invention so as not to obscure the disclosure with details that will be readily apparent to those with ordinary skill in the art having the benefit of the description herein.

While the specification concludes with the claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

It will be appreciated that embodiments of the invention described herein may include one or more conventional processors and unique stored program instructions that control the one or more processors to implement, in conjunction with certain non-processor circuits, some, most, or all of the functions related to displaying advertisements on computing devices described herein. The non-processor circuits may include, but are not limited to, a radio receiver, a radio transmitter, signal drivers, clock circuits, power source circuits, and user input devices. As such, these functions may be interpreted as steps of a method to display advertisements on computing devices. Methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

System Overview

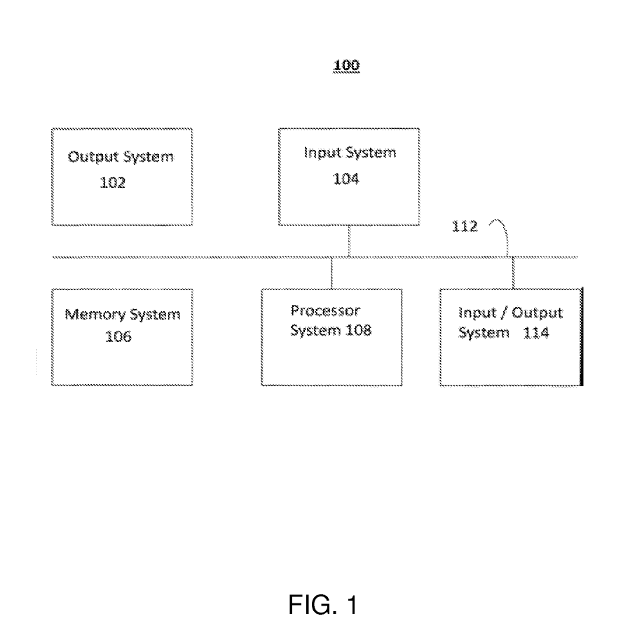

FIG. 1 shows a block diagram of a system 100 used in the method for advertising on computing, mobile, and/or other devices. The system may include an output system 102, an input system 104, a memory system 106, a processor system 108, a communications system 112, and an input/output device 114. In other embodiments, the system 100 may include additional components and/or may not include all of the components listed above. Examples of system 100 include a personal computer, a workstation, a laptop, a game console, a handheld network enabled audio/video player, a mobile phone and a personal digital assistant.

System 100 is an example of a system that may be used for the method for advertising on computer devices. System 100 allows the integration of advertisements into installed applications without the need to modify these applications. The methods disclosed in this specification may be implemented on hardware systems such as system 100, which allow the integration of advertisements into installed and existing applications.

Output system 102 may include, for example, any one of, some of, any combination of, or all of a monitor system, a handheld display system, a printer system, a speaker system, a connection or an interface system to a sound system, an interface system to peripheral devices and/or a connection and/or interface system to a computer system, intranet, and/or internet. Output system 102 may also be interchangeably referred to as a display module during the description of the invention. Output system 102 may display or otherwise output any type of advertisement, including visual and audio output. Advertisements may also be interchangeably referred to as contents or advertising contents or ads during the description of the invention. Output system 102 may include lights, such as a red light and/or a flashing light. Output system 102 may include a speaker that is part of a headset or an output port for a speaker. Input system 104 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. Input system 104 may an input for a microphone that is part of a headset. If system 100 is a mobile device, system 100 may include a telephone keypad. Memory system 106 may include, for example, any one of, some of, any combination of, or all of a long term storage system, such as a hard drive; a short term storage system, such as random access memory; a removable storage system, such as a floppy drive or a removable drive; and/or flash memory. Memory system 106 may also be interchangeably referred to as a memory module during the description of the invention. Memory system 106 may include one or more machine-readable mediums that may store a variety of different types of information. The term machine-readable medium is used to refer to any medium capable carrying information that is readable by a machine. One example of a machine-readable medium is a computer-readable medium. Memory system 106 allows the system to remember/store, for example, information including but not limited to: a list of applications, algorithms, previous events, registered applications, which ads go with which applications, fees for advertising, number of ads send to customers, customer's reaction to ads, and advertisements. Memory system 106 may store computer instructions for implemented the methods discussed in the remainder of this specification. In an embodiment, memory system 106 can store a configuration data including at least one set of predefined parameters corresponding to at least one application installed or running on system 100. In another embodiment, memory system 106 can store at least one content, for example an advertisement to be displayed on system 100.

In an embodiment, system 100 can additionally include a tracking module. The tracking module being configured to monitor activity of the application on the computing device and detect an event during activity of the application on the computing device, such that occurrence of the event is an indication to display the advertising content.

Processor system 108 may include any one of, some of, any combination of, or all of multiple parallel processors, a single processor, a system of processors having one or more central processors and/or one or more specialized processors dedicated to specific tasks. Processor system 108 may run a program stored on memory system 106 for identifying an application from a list of applications, analyzing/detecting events from one or more user computing devices and decides whether to send an ad and/or which ad to send. Processor system 108 may implement the algorithm of ad display identifying the need for an ad display 100. Processor system 108 can keep track of user actions with respect to ads. Processor system 108 may implement the computing device's instructions stored in memory system 106, based on information stored in memory system 106.

In an embodiment, processor 108 can retrieve the configuration data from a first server, the configuration data includes predefined parameters that enable the processor to identify the advertisement to be displayed corresponding to the application. Processor 108 is also configured to retrieve the configuration data from the first server and then storing the configuration data in the memory system 106. The processor 108 can retrieve one or more advertising contents from a second server based on the predefined parameters before storing the one or more advertising contents in the memory module.

Communications system 112 communicatively links output system 102, input system 104, memory system 106, processor system 108, and/or input/output system 114 to each other. Communications system 112 may include any one of, some of, any combination of, or all of electrical cables, fiber optic cables, and/or means of sending signals through air or water (e.g. wireless communications), or the like.

Input/output system 110 may include devices that have the dual function as input and output devices. For example, input/output system 110 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 110 is optional, and may be used in addition to or in place of output system 102 and/or input device 104. Input/output system 110 can be used by developers, customers (users) and/or system administrators. The advertising content is displayed on at least a portion of input output system 110, for example, if the input output system is a display screen the advertising content will cover at least a portion of the display screen. In an embodiment, the advertising content will cover the entire area of the display screen.

In an embodiment, system 100 may also include a reporting module. The reporting module is configured to monitor a response of the user to the advertising content and report information received from the user. The information is indicative of a response of the user to the advertising content. The information includes a unique identifier of the application, a unique identifier of the developer's account, results of displaying the advertisement, i.e., whether the user clicked the advertisement to view it, whether the advertisement was simply closed, or time that the display elapsed before it was closed.

Examples of the predefined parameters include, but are not limited to a unique identifier for the application, a duration of displaying the advertising content, and a parameter for checking type of the event.

Examples of the event during activity of the application include, but are not limited to, a start of the application, an end of the application, a transition from the application to another application, and a transition back from another application to the application.

Once the tracking module detects any of the events mentioned above, processor 108 functions to retrieve the configuration data corresponding to the application. The configuration data includes the predefined parameters related to the application as defined by the developer. Thereafter, based on the predefined parameters, processor 108 directs the output system 102 or display module to display the advertising content input/output system 110. Subsequently, the invention also provides an embodiment, in which the reporting module reports the interaction of user of system 100 with the advertising content displayed on system 100.

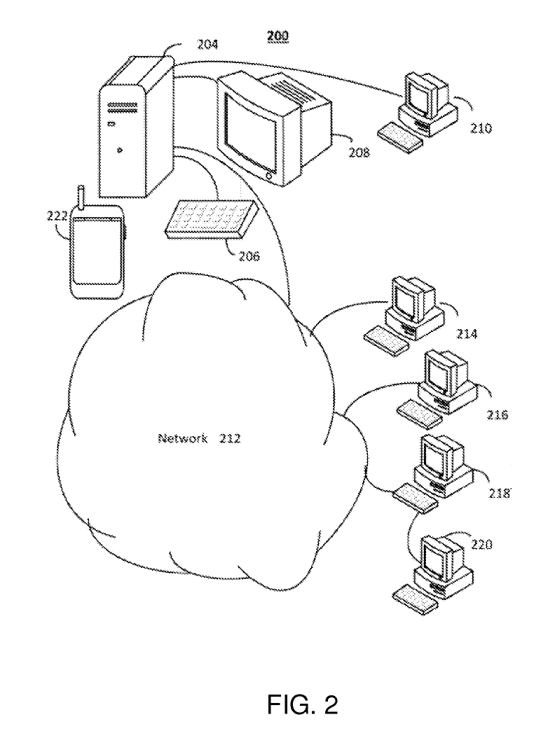

FIG. 2 shows an example of a system 200 used in the method for advertising on computer devices. System 200 may include a second server, for example an advertising server system 204 having an input system 206 and an output system 208. System 200 also includes a system 210, a network 212, user mobile or stationary computer device(s) 214, 216, 218, 220, and 222. In other embodiments system 200 may not have all of the components listed above or may have other components instead of and/or in addition to those listed above. Advertising server system 204 may also be interchangeably referred to as the second server 204, an advertising server 204, and a server system 204 during the description of the invention.

System 200 illustrates some of the variations of the manners of connecting to the server system.

Advertising server system 204 may include a webserver application. Server system 204 is directly connected to system 210, and is connected, via network 212, to user device(s) 214, 216, 218, and 220. In some embodiments, user device 220 is connected to user device 204 via user device 218. Network 212 may be any one of, or any combination of, one or more Local Area Networks (LANs), Wide Area Networks (WANs), wireless networks, telephones networks, and/or other networks. User devices 210, 214, 216, and 218 are any device that an end user may use to access server system 204. Alternatively, one or more of User devices 210, 214, 216, and/or 218 can be used by developers. For example, user/developer devices 210, 214, 216, and 218 may be personal computers, workstations, laptop computers, game consoles, handheld network enabled audio/video player, and/or any other network appliance. User (or developer) device 220 is an example of a device that accesses server system 204, via the combination of network 212 and another device, which in this example is user device 218. User (or developer) device 222 is an example of a handheld network wireless device, such as a mobile phone or a handheld network enabled audio/music player, which may also be used for accessing network content.

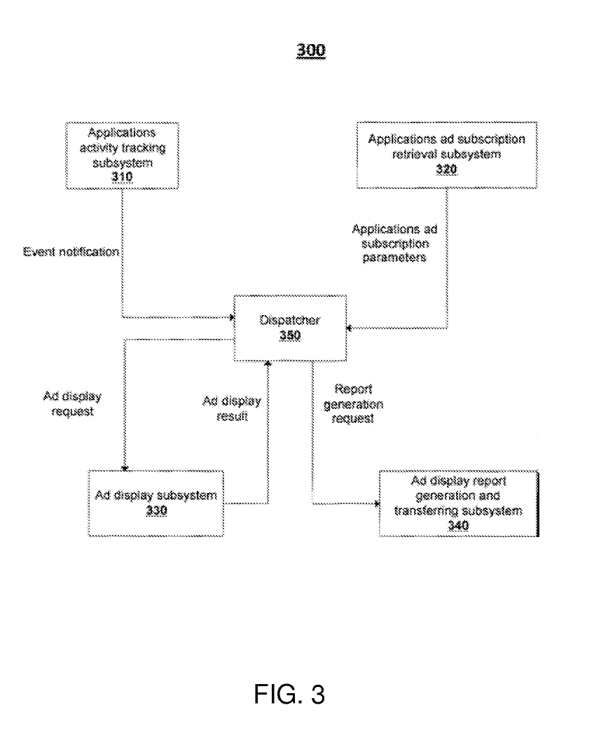

FIG. 3 shows a block diagram of an embodiment of a hardware system 300 for advertising on computing devices. The hardware system 300 may include an applications activity tracking subsystem 310, an applications ad subscription retrieval subsystem 320, a dispatcher 350, an ad display subsystem 330 and an ad display report generation and transferring system 340. The components of system 300-350 are all in intercommunication, either via a communications line or wirelessly. In other embodiments hardware system 300 may not have all of the elements or features listed and/or may have other elements or features instead of or in addition to those listed.

System dispatcher 350 is the main connecting and control component and acts a processor or a computing module in hardware system 300. System dispatcher 350 receives information and notifications and sends requests to other subsystems/modules. Features of system dispatcher 350 include, but are not limited to: 1. Receipt and storage of data from the applications ad subscription retrieval subsystem 320; 2. Receipt of notifications from the applications activity tracking subsystem 310; 3. Identifying the need for ad display for each notification; 4. Initiation of ad display through ad display subsystem 330; 5. Retrieval of ad display result from the ad display subsystem; 6. Report sending through the ad display report generation and transferring subsystem 340.

Upon system start, dispatcher 350 initiates the downloading of application's configuration data and starts the applications activity tracking subsystem 310. After that, dispatcher 350 waits for applications activity notifications from applications activity tracking subsystem 310. The purpose of applications activity tracking subsystem 310 is to monitor the applications installed and running on a computing device. Examples of events activity tracking subsystem 310 can track include, but are not limited to: 1. Application start; 2. Application closing; 3. Application losing focus—occurs when another application becomes active; and/or 4. Application gaining focus—occurs when the current application becomes active.

In another embodiment, provided operating system of the computing device supports it, applications activity tracking subsystem 310 may detect a window identified by a predefined window class or a predefined window name. This embodiment is possible, for example, under Windows. In yet another embodiment, for example under Windows, applications activity tracking subsystem 310 may detect a change in value of a certain registry parameter or the creation, modification, or deletion of a certain file in a certain directory. In the general case, applications activity tracking subsystem 310 may detect any applications activity made detectable by the operating system used in the embodiment.

Upon the occurrence of any of the above events, applications activity tracking subsystem 310 notifies dispatcher 350.

Ad display system 330 allows advertising content to be downloaded from the advertising server through a communication channel. The advertising content may be in the form of text, image, animation, etc. The advertising content may contain a hyperlink. In such a case, the user may click the advertising content to open the hyperlink in a browser. The advertising content may be downloaded immediately before display, or preliminarily with caching. In the latter case, the advertising content is stored in a temporary or a permanent memory, for example the memory module/memory subsystem 106 of the computing device, and is used as needed. Ad display reports are sent to the advertising server through a communication channel. Such reports include the identification of the ad serving application, as well as the identification of the application developer's account. Such reports can also include, but are not limited to: the results of the display, whether the user clicked the advertisement to view it, whether the advertisement was simply closed, or the time that the display elapsed before it was closed.

Method 300 can be implemented as a constantly running application such as a service or daemon. Keeping the application constantly running allows for continuous monitoring of the activity of other applications.

In another embodiment, provided the operating system supports it, the system of the present invention may be implemented as a common application which subscribes to certain application activity events, which may be automatically started by the operating system when such events occur.

In yet another embodiment, provided the operating system supports it, method 300 may be implemented as a dynamic loading library which automatically loads to each started application. Under Windows, for example, one of such mechanisms is named DLL injection.

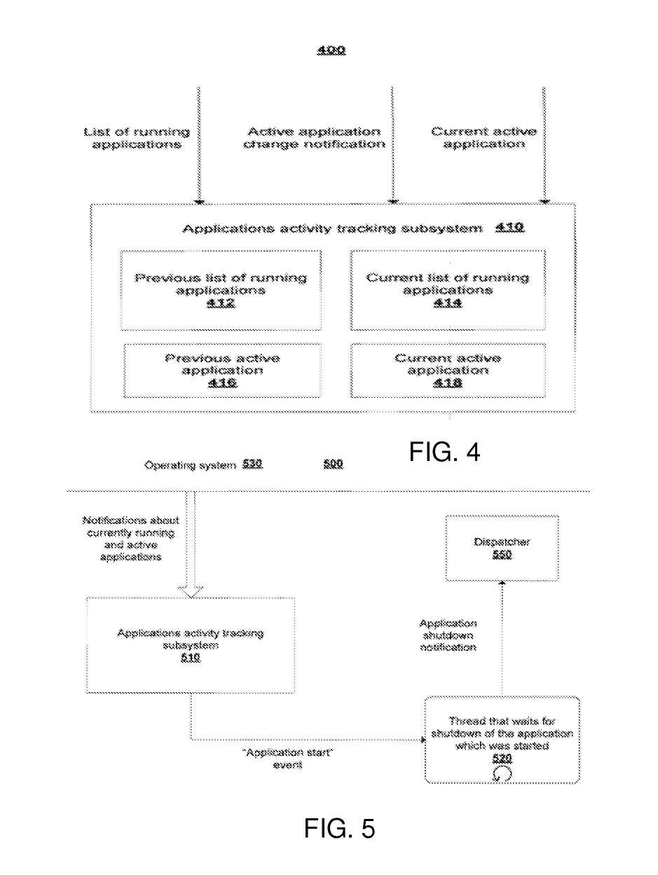

FIG. 4 shows a block diagram of an operating system 400 which may be incorporated within hardware system 300 of FIG. 3. The applications activity tracking subsystem 410 may have various embodiments, depending on the features of the operating system. The following embodiment may be used with Windows and Symbian, for example. The operating system 400 provides a list of running applications, and the currently active application, and may send out notifications of the active application change. Applications activity tracking subsystem 410 may include a previous list of running applications 412, a current list of running applications 414, previous active applications 416, and current active applications 418. In other embodiments applications activity tracking subsystem 410 may not have all of the components listed above or may have other components instead of and/or in addition to those listed above and/or may use a different operating system.

Applications activity tracking subsystem 410 may be an embodiment of server 204, system 300 and/or system 100. Alternatively or additionally, operating system 400 may be an embodiment of a hardware system 100 for advertising on computing devices and 400 and/or 410 is contained within one unit.

In some embodiments, applications activity tracking subsystem 410 stores two lists of running applications: preceding list 412 and current list 414. Upon receipt of a notification of the active application change from operating system 400, the current list of running applications is retrieved and compared to preceding list of running applications 412 as follows: 1. Applications present in the preceding list but absent from the current list are found. Applications in the preceding list and absent form the current list are applications which were shut down, and detecting Applications in the preceding list and absent form the current list indicates an application closing event; 2. Applications present in the current list but absent from the preceding list are found. Applications present in the current list but absent from the preceding list are newly started applications, and detecting Applications present in the current list but absent from the preceding list detects application start events; Next, current list of running applications 414 replaces preceding list of running applications 412.

Applications activity tracking subsystem 410 stores preceding 416 and current 418 active application(s). Upon the receipt of a notification of the active application change from the operating system, the current active application is retrieved. If preceding 416 and current 418 active applications differ, the following events are detected: events in which the preceding application lost focus and events in which current applications gain focus. After that, current active application 418 replaces preceding active application 416.

FIG. 5 shows a block diagram of a system 500 in which an application closing event may be detected by the following method. This embodiment may be implemented with Windows, Symbian, or another operating system. System 500 may include an applications activity tracking subsystem 510, a dispatcher 550, and a thread that waits for shutdown of the application which was started by thread of execution 520. In other embodiments, system 500 may include additional components and/or may not include all of the components listed above.

When an application start event is detected, applications activity tracking subsystem 510 creates separate thread of execution 520 which waits for the started application to shut down. At the end of waiting, an application closing event is detected, and thread 520 notifies dispatcher 550. Depending on the algorithm, an ad may be sent upon start or upon shutdown.

In a further embodiment, when the DLL injection mechanism is used, applications activity tracking subsystem 510 detects applications start and closing in the following way. When any of the applications is started, a dynamic library is automatically loaded to its address space and the DLLMain callback function with a DLL_PROCESS_ATTACH parameter is called in this library. The DLL_PROCESS_ATTACH parameter causes the DLL that was just loaded in memory to be attached (loaded) into the process memory space of the application associated with this process. So, DLL thus becomes part of the process. When any of the applications is closed, the dynamic library is automatically unloaded from its address space and the DLLMain callback function with a DLL_PROCESS_DETACH parameter is called in this library. Similarly, the DLL_PROCESS_DETACH parameter causes the DLL to be detached (unloaded) from the process memory space of the application associated with this process. So, DLL is thus no longer part of the process. Thus, in fact, operating system 530 itself reports applications start and closing, which may be performed with Windows or another operating system.

In a further embodiment, a polling mechanism may be used which assumes that the system requests a list of running applications from operating system 530 at regular intervals. Operating system 530 stores the preceding list of running applications and compares it to the current list of running applications by detecting application start and application closing events in a way similar to the embodiment illustrated in FIG. 4. This embodiment is possible for any platform, for example Windows, Symbian, Android.

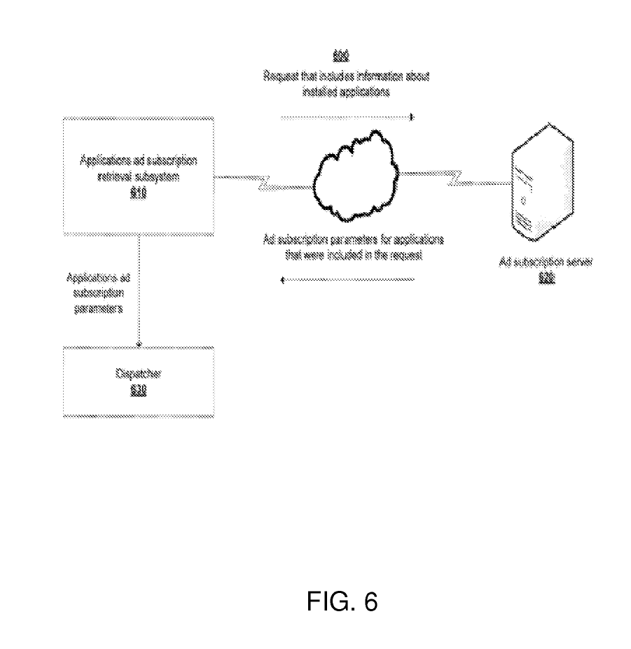

FIG. 6 illustrates one of the possible embodiments of an applications ad subscription retrieval subsystem 610. System 600 includes Applications ad subscription retrieval subsystem, a first sever, for example an ad subscription server 620, and a dispatcher 630. In other embodiments system 600 may not have all of the components listed above or may have other components instead of and/or in addition to those listed above.

Applications ad subscription information may be interchangeably referred as configuration data in the description of the invention. The applications ad subscription information is stored on a dedicated first server or subscription server 620. The purpose of applications ad subscription retrieval subsystem 610 is to download relevant information corresponding to the application from subscription server 620 through a communication channel and transfer it to dispatcher 630.

Applications ad subscription retrieval subsystem 610 sends to subscription server 620 information which identifies applications installed on a computing device. In response, subscription server 620 sends ad subscription information for those applications from the request which are in subscription server 620's database. This information is received by applications ad subscription retrieval subsystem 610 and transferred to system dispatcher 630. Requests for information are sent at regular intervals.

In a further embodiment, applications ad subscription information may be requested upon the occurrence of certain events, such as new application installation or application deletion. In this case, if it is impossible to download the information (for example, due to a connection loss), a downloading attempt is delayed until the next scheduled point of time. In a further embodiment, the next downloading attempt may be scheduled for an earlier point of time.

Information that identifies the applications installed on a computing device varies depending on the operating system. Information that identifies applications should, if possible, uniquely identify each application. For example, the information that identifies applications may include one or more of the following: 1. The full installation path or the name of the executable file of the application; 2. The size of the executable file of the application; 3. The value of some hash function calculated for the content of the executable file of the application. For example, the hash function may be CRC or MD5; 4. A digital signature which identifies the application; 5. The name of the registry key where the full path to the executable file of the application is stored (under Windows); 6. The class name of the main application window (under Windows); and/or 7. The system ID of the application (under Symbian and Android).

In a further embodiment, applications ad subscription retrieval subsystem 610 may send a special request instead of sending the information on applications installed on a computing device to subscription server 620. In this case, subscription server 620, in response, sends the ad subscription information for all applications which are in the server database.

The applications ad subscription parameters or the configuration data which subscription server 620 returns may include, but are not limited to, the following: 1. A parameter indicating whether to display ads upon application start; 2. A parameter indicating whether to display ads upon application shutdown; 3. A parameter indicating whether to display ads upon application gaining focus; 4. A parameter indicating whether forced application shutdown is allowed; 5. A parameter indicating whether to display ads when a window with a predefined title appears; 6. A parameter indicating whether to display ads when a window with a predefined window class name appears (under Windows). The use of the ‘Whether forced application shutdown is allowed’ parameter is disclosed in the below description of the ad display subsystem.

In a still further embodiment, a ‘Whether to display ads upon application losing focus’ parameter may be used. However, its use on devices without a telephone is preferred. On mobile computing devices (smart phones) ad display upon application losing focus in some cases may prevent the user from answering calls.

Applications ad subscription parameters returned by subscription server 620 can include the identification (ID) of the account of the developer of each application; the identification ID can be used in ad display reporting and payments. Also, for each application, subscription server 620 can return its ID, which, together with the developer's account ID, uniquely identifies the application. In a still further embodiment, the developer's account ID may not be used. The developer's account ID may be replaced with a unique ID of the application which is generated by subscription server 620 and uniquely identifies the developer of the application.

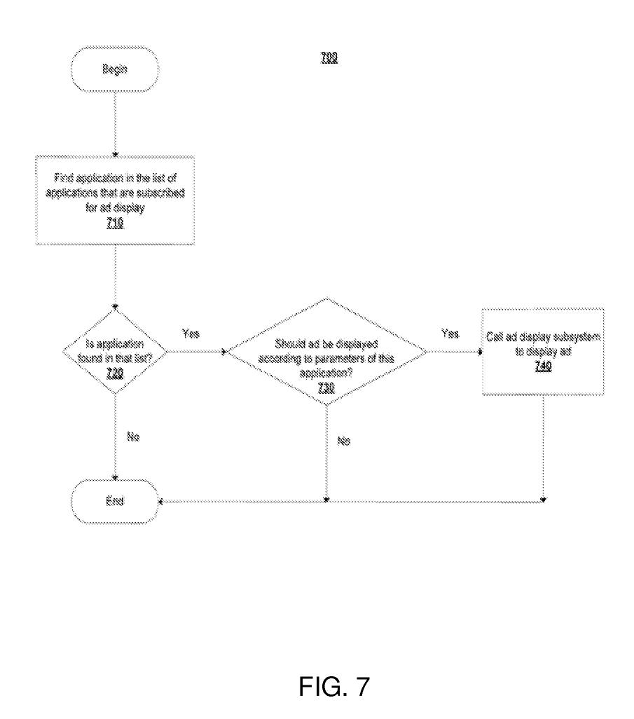

Embodiments of the methods and algorithms used therein are now described with reference to FIGS. 7-9. In an embodiment, each of the steps of methods in FIGS. 7-9 is a distinct step. In another embodiment, although depicted as distinct steps in FIGS. 7-9, steps may not be distinct steps. In other embodiments, methods in FIGS. 7-9 may not have all of the above steps and/or may have other steps in addition to or instead of those listed above. The steps of methods in FIGS. 7-9 may be performed in another order. Subsets of the steps listed above as part of methods in FIGS. 7-9 may be used to form their own method.

A. Method for Identifying the Need for an Ad Display

FIG. 7 is a flowchart showing an embodiment of a method 700 for identifying the need for an ad display. When the dispatcher receives an activity notification (start, activation, etc.) for an application, it defines whether ads are to be displayed.

As shown in FIG. 7, method 700 includes the steps of finding an application in the list of applications that are subscribed for ad display at step 710, identifying whether the application is found in that list at step 720, if the application is not found (if “no”), the method is terminated. If the application is found (if “yes”), method 700 identifies whether the ad should be displayed according to the parameters of this application at step 730. If the application should not be displayed (if “no”), method 700 is terminated. If the application should not be displayed (if “yes”), method 700 calls an ad display subsystem to display ad at step 740. If at any point the decision is made not to display the ad, method 700 may be ended by turning off one or more parts of the hardware system (e.g., hardware system 100) or by waiting for a new notification. Method 700 terminates when the service or daemon implementing the system of the current invention terminates (which happens, for instance, when the device is turned off).

In other embodiments, method 700 may not have all of the steps listed and/or may have other steps instead of or in addition to those listed.

In step 710, the application for which the activity notification was received is searched for in the list of applications that are subscribed for ad display. This step can be performed by the ad server and/or processor and can use any of the subsystems described herein.

In step 720 it is identified whether the application is found in that list.

If “yes”, the parameters are analyzed to decide whether the ad should be displayed at step 730. Thus, information in the memory tells whether ads are to be displayed for this particular notification subject to the ad subscription parameters of the application and which ad or ads is displayed. The type of ad can be dependent upon the person using the application. In an embodiment, the developer of the application has a means to modify the ad display behavior through the server-based parameters, without ever touching the application itself. Many other parameters may also be taken into account, such as the location, user preferences, etc. For example, an application may be subscribed to ads upon shutdown, but not subscribed to ads upon start. Alternatively, an application may be subscribed to ads upon start, but not subscribed to ads upon shutdown.

If “yes”, an ad display subsystem is called upon to display the ad at step 740. If, as a result of these checks, the need for ad display is identified, the dispatcher gives a relevant command to the ad display subsystem to display the ad. The ad can be any type of ad including any of those discussed herein.

Cases of application restart and application reactivation may be separately tracked. For example, if an application was forced to shut down upon its start for ad display, the system will restart it after ad display. In this case, the applications activity tracking subsystem will report the start of this application. But this start will be ignored. Similarly, when ads are displayed upon application activation, this application will be reactivated after the advertisement is closed. The applications activity tracking subsystem will report the activation of this application, which will also be ignored. For this purpose, the system has data structures such as lists where identifications of ad serving applications are temporarily entered immediately before the advertisement is displayed. For the purpose of convenience and simplification, in the below disclosure these are conventionally called list A, where application IDs are entered when ads are displayed upon application start, and list B, where application IDs are entered when ads are displayed upon application activation. When the next notification of application start or activation is received, this notification is ignored if the ID of the application is found in the relevant list. And the ID of this application is removed from the list. The application is terminated until another notification is received to start

B. Method of Ad Display Upon Application Start

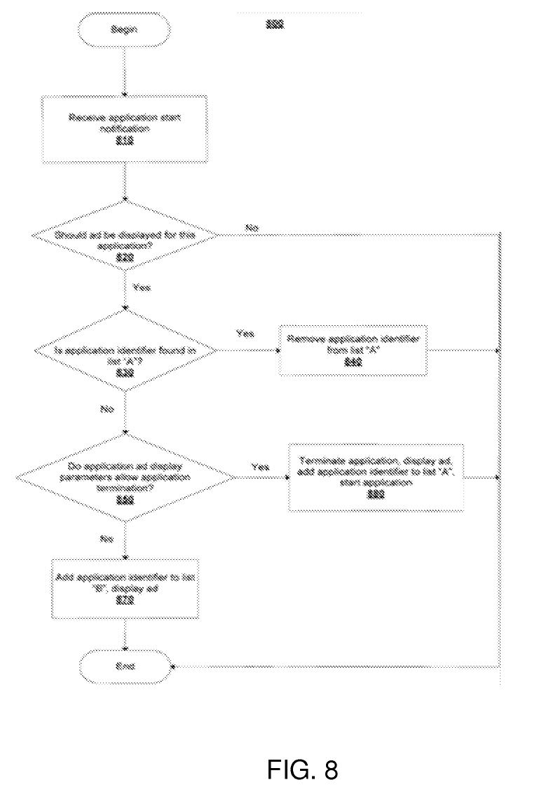

Other embodiments of the method in the case of an ad display upon application start are illustrated in FIG. 8. A notification is received that an application is started at step 810. The system defines whether ads are to be displayed for the specific application at step 820. If the answer is positive (“yes”) at step 830, the application ID is searched for in list A (where application IDs are entered when ads are displayed upon application start). If the ID is found, it is removed from list A and ads are not displayed at step 840. Otherwise, (if “no”) the system checks whether forced application shutdown is allowed in the ad subscription parameters of the application at step 850. If the answer is positive (“yes”), the following operations are carried out: the application is closed, the advertisement is displayed, the application ID is added to list A, and the application is started at step 880. Otherwise (if “no”), the application ID is added to list B (where application IDs are entered when ads are displayed upon application activation) and the advertisement is displayed at step 870. If the decision is made not to display an ad, the method may be ended by turning off one or more parts of the hardware system (e.g., 100) or the application. In other embodiments, method 800 may not have all of the steps listed and/or may have other steps instead of or in addition to those listed.

In step 810, a notification is received for application start. The notification can be received from the applications activity tracking subsystem and/or the ad server and/or the operating system.

In step 820, a decision is made as to whether an ad should be displayed for this application. The decision can be based on which list the application is on (A or B), advertising parameters for a specific advertiser, user preferences, and/or other information received by the system. If “no”, the algorithm is terminated.

If “yes” in step 820, then in step 830 a decision is made as to whether the application identifier is found in list “A”. List A is where application IDs are entered when ads are displayed upon application start, and list B is where application IDs are entered when ads are displayed upon application activation.

If “yes” in step 830, then in step 840 the application identifier is removed from list “A” and the method is terminated.

If “no” in step 830, then in step 850 a decision is made as to whether the application ad display parameters allow application termination. If “yes,” the application is terminated, an ad is displayed, and the application identifier is added to list “A”, and the application is started, after which the application is terminated.

If “no” in step 850, then in step 870, the application identifier is added to list “B”, and the ad is displayed, after which the application is terminated until another notification is received to start.

C. Method of Ad Display Upon Application Activation

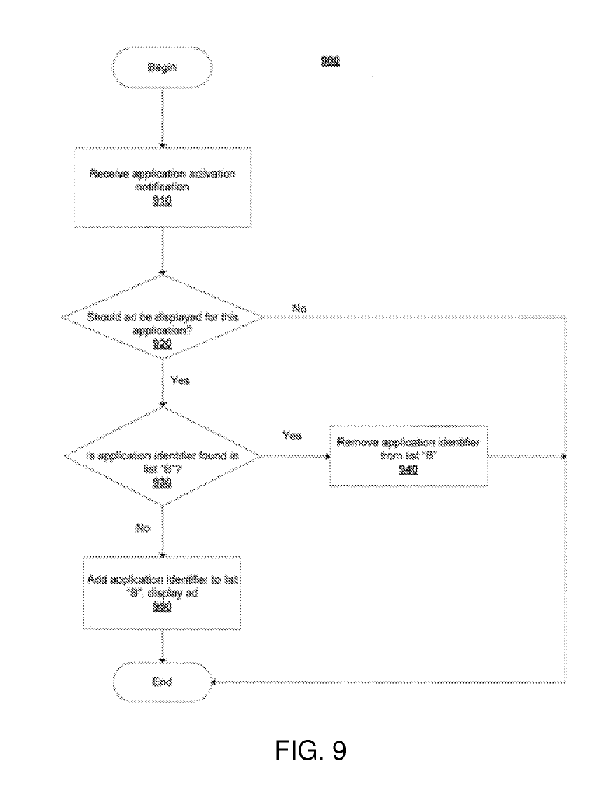

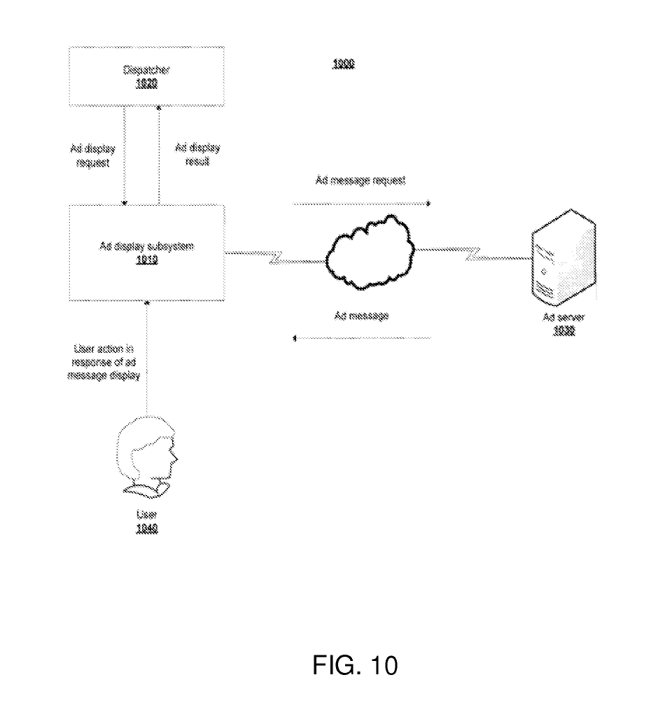

FIG. 9 is a flowchart of an embodiment of a method 900 in which the ad is displayed upon activation of the application. This is another approach or type of algorithm that can be used. The method 900 may include the following steps: a notification is received that some application is activated at step 910, the system defines whether ads are to be displayed at step 920. If the ads are to be displayed, the application ID is searched for in list B at step 930. If the ID is found, it is removed from list B and ads are not displayed at step 940. Otherwise, the application ID is added to list B and the advertisement is displayed at step 950. If the decision is made not to continue monitoring, the method may be ended by turning off one or more parts of the hardware system (e.g., 100). In other embodiments, method 900 may not have all of the steps listed and/or may have other steps instead of or in addition to those listed.

In step 910 a notification is received that an application is activated. The notification can be received from the applications activity tracking subsystem and/or the ad server, and/or the operating system.

In step 920 the system defines whether ads are to be displayed. Whether ads are displayed may be based on which list the application is on (A or B), advertising parameters for a specific advertiser, user preferences, and/or other information received by the system.

In step 930, the application ID is searched for in list B. List B is where application IDs are entered when ads are displayed upon application activation.

If the application ID is in list B, in step 940, the application ID is removed from list B and ads are not displayed.

If the application ID is not in list B, in step 950, the application ID is added to list B and the advertisement is displayed. Monitoring may be continued and the process restarted upon notification of an event. Alternatively, the method can be terminated upon shutdown of application and/or user device.

Ad Display Subsystem

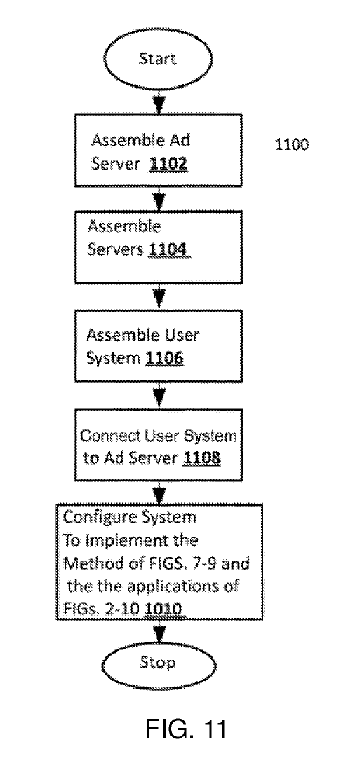

FIG. 10 shows a block diagram of an ad display subsystem 1000 used in the method for advertising on computer devices. The system may include dispatcher 1020, ad display subsystem 1010, ad server 1030, and user 1040. In other embodiments, system 1000 may include additional components and/or may not include all of the components listed above.

The purpose of ad display subsystem 1010 is to download an advertisement from advertising server 1030, display it on the screen of a computing device and store the action performed by the user of computing device 1040 with the advertisement. The user's action is transferred to system dispatcher 1020. An advertisement may be in the form of a text message, image, animation, etc. An advertisement may be displayed in a window taking some part of the screen of a computing device or in the full-screen mode. An advertisement may contain a hyperlink. In this case, if user 1040 clicks the advertisement, the hyperlink opens in the web browser installed on the computing device. Subsystem 1010 tracks and stores user 1040 actions including, but not limited to: 1. No user response to the advert. After a certain time elapses, the advertisement is closed; 2. The user explicitly closed the advertisement; 3. The user clicked the advertisement.

After the end of displaying the advertisement, ad display subsystem 1010 sends to dispatcher 1020 a notification with the result of the ad display (user response). Dispatcher 1020 initiates the generation of an ad display report by transferring the ad display result to the ad display report generation and transferring subsystem.

If it is impossible to download the advertisement from the advertising server (for example, due to a connection loss), the system uses one of the predefined advertisements. In another embodiment, the system may display no ads at all in case it is impossible to download the advertisement. The advertising server may be implemented together with subscription server 1030 or as a standalone server.

The ad display report generation and transferring subsystem 1010 can receive data from the dispatcher including but not limited to: 1. ID of the ad serving application; 2. ID of the application developer's account; and/or 3. Result of ad display (user action).

The ad display report generation and transferring subsystem generates a request which includes at least the above information and sends the above information to the reporting server. The reporting server may be implemented together with the advertising server or as a standalone server.

In a still further embodiment, the ad display subsystem may download from the advertising server one or several control values in addition to the advertisement itself. These values are transferred to the ad display report generation and transferring subsystem input and together with the above data are sent to the reporting server.

Methods of Making the System

FIG. 11 provides a flow diagram of a method of making system 1100. The system can be assembled in any manner known to create a workable system for performing the methods described herein. For example, ad server is assembled at step 1102. The ad server can include any one of or combination of ad subscription server, report server, application activity tracking subsystem, dispatcher, application ad subscription retrieval subsystem and/or any other subsystem discussed herein. The user system can be assembled at step 1104. The user and ad server system can be assembled using methods known to the skilled artisan. The user system is then connected to the ad server system in step 1106. The connection can be using any method known to the skilled artisan including a wireless connection. The appropriate algorithms are installed in step 1108 for any of the methods discussed herein, including methods 700, 800, and/or 900.

In an embodiment, the invention also includes one or more machine-readable mediums in form of a computer program product that may store a variety of different types of information. The term machine-readable medium is used to refer to any medium capable of carrying information that is readable by a machine. One example of a machine-readable medium is a computer-readable medium. The computer program product can carry instructions for carrying out the method of displaying advertisements on a computing device as described above.

Each embodiment disclosed herein may be used or otherwise combined with any of the other embodiments disclosed. Any element of any embodiment may be used in any embodiment.

As may be seen from the foregoing by a person skilled in the relevant art, at least some embodiments of the system and methods of the present invention provide an easy to use, flexible, and complete advertising system for developers of applications, thus allowing the developers to take advantage of the revenues coming from the many existing advertising networks or other sources of advertising content.

Aspects, features, techniques, and advantages described herein are not all-inclusive, and, in particular, many additional aspects, features, techniques and advantages will be apparent to one of ordinary skill in the art in view of the figures and the following description of the preferred embodiments of the present invention.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method of displaying a content on at least a portion of a display screen of a computing device, said computing device capable of running an application, said method comprising:
a. accessing a set of predefined parameters associated with said application;
b. determining said content based on said set of predefined parameters;
c. detecting an event associated with said application; and
d. displaying said content based on detection of said event without modification to said application.

2. The method of claim 1, wherein said content is an advertising content.

3. The method of claim 1, wherein said displaying comprises occupying an entire screen area of said display screen with said content.

4. The method of claim 1, wherein said displaying comprises occupying a window on said display screen with said content, wherein said window overlaps with a window of said application.

5. The method of claim 1, wherein said event is at least one of a start of said application, an end of said application, a transition from said application to another application, and a transition back from another application to said application.

6. The method of claim 1, wherein said set of predefined parameters is at least one of a unique identifier for said application, a duration of displaying said content, and a parameter for checking a type of said event.

7. The method of claim 1, wherein said computing device is one of a personal computer, a workstation, a laptop, a game console, a handheld network enabled audio/video player, a mobile phone and a personal digital assistant.

8. The method of claim 1, wherein said accessing comprises retrieving said set of predefined parameters from a first server, said first server comprising one or more sets of predefined parameters corresponding to one or more applications.

9. The method of claim 8, further comprising storing said set of predefined parameters in a memory of said computing device.

10. The method of claim 1, wherein said accessing comprises retrieving said set of predefined parameters from a memory of said computing device, said memory comprising one or more sets of predefined parameters corresponding to one or more applications.

11. The method of claim 1 further comprising obtaining said content from a second server based on said set of predefined parameters, said second server comprising one or more contents.

12. The method of claim 1 further comprising obtaining said content from a memory of said computing device based on said predefined parameters, said memory comprising one or more contents.

13. The method of claim 1 further comprising detecting a moment of a window of said application being displayed and displaying said content at said moment, wherein said window includes predefined characteristics including at least one a window class, a window name.

14. The method of claim 1 further comprising monitoring an interaction with said content by at least one of a user of said computing device and said application.

15. A computing device, said computing device configured to display a content on at least a portion of a display screen of said computing device, said computing device comprising:
a. a memory, said memory configured to store at least one of:
i. at least one set of predefined parameters corresponding to at least one application; and
ii. at least one content;
b. a tracking module, said tracking module being configured to detect an event associated with an application on said computing device;
c. a processor, said processor configured to obtain a set of predefined parameters corresponding to said application, wherein said set of predefined parameters enable said processor to identify said content of said at least one content; and
d. a display module, said display module configured to display said content on said display screen.

16. The computing device of claim 15, wherein said content is an advertising content.

17. The computing device of claim 15 is one of a personal computer, a workstation, a laptop, a game console, a handheld network enabled audio/video player, a mobile phone and a personal digital assistant.

18. The computing device of claim 15, wherein said content occupies an entire screen area of said display screen.

19. The computing device of claim 15, wherein said event associated with said application is at least one of a start of said application, an end of said application, a transition from said application to another application, and a transition back from another application to said application.

20. The computing device of claim 15, wherein said predefined parameters is at least one of a unique identifier for said application, a duration of displaying said advertising content, and a parameter for checking type of said event.

21. The computing device of claim 15, wherein said processor is configured to obtain said at least one set of predefined parameters from a first server before storing said at least one set of predefined parameters in said memory, said first server comprising one or more of sets of predefined parameters corresponding to one or more applications.

22. The computing device of claim 15, wherein said processor is configured to obtain at least one content from a second server based on said set of predefined parameters before storing said at least one content in said memory, said second server comprising one or more contents.

23. The computing device of claim 15 further comprising a monitoring module, said monitoring module being configured to monitor an interaction with said content by at least one of a user of said computing device and said application.

24. A system for displaying a content on at least a portion of a display screen of a computing device, said system comprising:
a. a first server, said first server comprising one or more sets of predefined parameters corresponding to one or more applications;
b. a second server, said second server comprising one or more contents; and
c. a computing module located on said computing device, said computing module configured to at least:
i. obtain a set of predefined parameters associated with an application from said first server;
ii. obtain a content based on said set of predefined parameters from said second server;
iii. detect an event associated with said application; and
iv. display said content on said at least portion of said display screen when said event is detected.

25. The system of claim 24, wherein said content is an advertising content.

26. The system of claim 24, wherein said at least portion is an entire screen area of said display screen.

27. The system of claim 24, wherein said event is at least one of a start of said application, an end of said application, a transition from said application to another application, and a transition back from another application to said application.

28. The system of claim 24, wherein said set of predefined parameters is at least one of a unique identifier for said application, a duration of displaying said advertising content, and a parameter for checking type of said event.

29. The system of claim 24 further comprising a monitoring module configured to monitor an interaction with said content by at least one of a user of said computing device and said application.

30. A method of displaying a content on at least a portion of a display screen of a computing device, said method comprising:
a. detecting an event associated with an application on said computing device;
b. retrieving a set of predefined parameters corresponding to said application from a first server, said first server comprising one or more sets of predefined parameters corresponding to one or more applications;
c. storing said set of predefined parameters retrieved from said first server in a memory of said computing device;
d. retrieving said content from a second server based on said set of predefined parameters on detecting said event;
e. storing said content retrieved from said second server in said memory of said computing device;
f. displaying said content on said display screen of said computing device; and
g. monitoring an interaction with said content by at least one of a user of said computing device and said application.

31. The method of claim 30, wherein said content is an advertising content.

32. The method of claim 30, wherein said at least portion is an entire screen area of said display screen.

33. The method of claim 30, wherein said event is at least one of a start of said application, an end of said application, a transition from said application to another application, and a transition back from another application to said application.

34. The method of claim 30, wherein said set of predefined parameters is at least one of a unique identifier for said application, a duration of displaying said content, and a parameter for checking type of said event.

35. A computer program product for use in a computing device, said computer program product configured to display a content on at least a portion of a display screen of said computing device, said computer program product comprising at least one computer-readable storage medium having computer-readable program code portions stored therein, said computer-readable program code portions comprising instructions for:
a. accessing a set of predefined parameters associated with an application capable of running on said computing device;
b. determining said content based on said set of predefined parameters;
c. detecting an event associated with said application; and
d. displaying said content based on detection of said event without modification to said application.
